(19) United States
(12) Patent Application Publication
(10) Pub. No.: US 2008/0068366 A1
(43) Pub. Date: Mar. 20, 2008

(54) Plasma display, and driving device and method thereof

(76) Inventors: Joon-Yeon Kim, Suwon-si (KR); Yong-Jin Jeong, Suwon-si (KR)

Correspondence Address: ROBERT E. BUSHNELL, 1522 K STREET NW, SUITE 300, WASHINGTON, DC, 20005-1202, US

(21) Appl. No.: 11/892,547

(22) Filed: Aug. 23, 2007

(30) Foreign Application Priority Data
Sep. 20, 2006 (KR) 10-2006-0091283

(51) Int. Cl. G06F 3/038; G09G 5/00

(52) U.S. Cl. 345/211

(57) ABSTRACT

In a plasma display device, a driver circuit and a method of driving that reduces costs by eliminating the need for high voltage transistors. A first terminal of an inductor is coupled to a plurality of first electrodes. A first terminal of a first capacitor is coupled to the first terminal of the inductor, a second terminal of the first capacitor is coupled to the plurality of first electrodes, a first terminal of a second capacitor is coupled to the first terminal of the inductor, and a second terminal of the second capacitor is coupled to the plurality of first electrodes. In addition, a resonance path for varying a voltage at the plurality of first electrodes is formed between a node of the first and second capacitors and the plurality of first electrodes. Further, a power source for supplying a first voltage is coupled to a first terminal of a first transistor, a first terminal of a second transistor is coupled to a second terminal of the first transistor, and a second terminal of a third transistor including a first terminal coupled to a second terminal of the second transistor is coupled to a power source for supplying a second voltage that is lower than the first voltage. The second terminal of the first transistor is coupled to the second terminal of the first capacitor, and the first terminal of the third transistor is coupled to the second terminal of the second capacitor.

### CLAIM OF PRIORITY

This application makes reference to, incorporates the same herein, and claims all benefits accruing under 35 U.S.C. § 119 from an application for PLASMA DISPLAY, AND DRIVING DEVICE AND METHOD THEREOF earlier filed in the Korean Intellectual Property Office on 20 Sep. 2006 and there duly assigned Serial No. 10-2006-0091283.

### BACKGROUND OF THE INVENTION

1. Field of the Invention

The present invention relates to a plasma display a driving apparatus and a driving method thereof.

2. Description of the Related Art

A plasma display panel (PDP) is a flat panel display that uses plasma generated by gas discharge to display characters or images. It includes, depending on its size, more than several scores to millions of pixels arranged in a matrix pattern.

One temporal frame of the plasma display is divided into a plurality of subfields respectively having weights, and grayscales are expressed by a combination of the weights of the subfields that are used to perform a display operation. Turn-on/turn-off cells (i.e., cells to be turned on or off) are selected during an address period of each subfield, and a sustain discharge operation is performed on the turned-on cells so as to display an image during a sustain period.

Specifically, since a high level voltage and a low level voltage are alternately applied to an electrode on which the sustain discharge operation is performed during the sustain period, a voltage of a transistor for applying the high and low voltages is required to correspond to a difference between the high level and the low level. Accordingly, the cost of a sustain discharge circuit is increased due to the high voltage of the transistor. What is needed is a less expensive alternative to these high cost and high voltage transistors.

### SUMMARY OF THE INVENTION

The present invention has been made in an effort to provide a plasma display for reducing a cost of a sustain discharge driving circuit, a driver and a driving method thereof.

According to one aspect of the present invention, there is provided a plasma display that includes a plurality of first electrodes, a first transistor including a first terminal coupled to a first power source for supplying a first voltage, a second transistor including a first terminal coupled to a second power source for supplying a second voltage that is lower than the first voltage, a third transistor including a first terminal coupled to a second terminal of the first transistor and a second terminal coupled to a second terminal of the second transistor, a first capacitor that is charged with a third voltage and that includes a first terminal coupled to the second terminal of the first transistor and the plurality of first electrodes, a second capacitor that is charged with a fourth voltage, and that includes a first terminal coupled to a second terminal of the first capacitor and a second terminal coupled to the second terminal of the second transistor and the plurality of first electrodes, a fourth transistor coupled between the first terminal of the first capacitor and the second terminal of the first transistor, a fifth transistor coupled between the second terminal of the second capacitor and the second terminal of the second transistor and a current path coupled between a node of the first and second capacitors and the plurality of first electrodes to change a voltage at the plurality of first electrodes.

The current path can include an inductor including a first terminal coupled to the node of the first and second capacitors and a sixth transistor including a first terminal coupled to a second terminal of the inductor and a second terminal coupled to the plurality of first electrodes. A body diode can be connected between the first terminal and the second terminal in the sixth transistor. The plasma display can also include a plurality of seventh transistors respectively including a first terminal coupled to the plurality of first electrodes and a second terminal coupled to the first terminal of the first capacitor, wherein the current path includes a plurality of eighth transistors respectively including a first terminal coupled to the second terminal of the sixth transistor and a second terminal coupled to the plurality of first electrodes. The plasma display can also include a ninth transistor coupled between the first terminal of the plurality of eighth transistors and the second terminal of the second capacitor. The plasma display can also include a controller adapted to establish the second, third, fourth, and sixth transistors to be turned on during a first period, establishing the second, fifth, and sixth transistors to be turned on during a second period, establishing the first, third, fifth, and sixth transistors to be turned on during a third period, establishing the first, third, fifth, seventh, and ninth transistors to be turned on during a fourth period, establishing the first, third, fifth, and eighth transistors to be turned on during a fifth period, establishing the second, fifth, and eighth transistors to be turned on during a sixth period, establishing the second, third, fourth, and sixth transistors to be turned on during a seventh period, and establishing the second, third, fourth, and eighth transistors to be turned on during an eighth period.

The plasma display can instead include a plurality of seventh transistors including a first terminal coupled the plurality of first electrodes and a second terminal coupled to the second terminal of the second capacitor, wherein the current path includes a plurality of eighth transistors including a first terminal coupled to the second terminal of the sixth transistor and a second terminal coupled to the plurality of first electrodes. The plasma display can also include a ninth transistor coupled between the first terminal of the plurality of eighth transistors and the first terminal of the first capacitor. The plasma display can also include a controller adapted to establish the second, third, fourth, and eighth transistors to be turned on during a first period, establishing the second, fifth, and eighth transistors to be turned on during a second period, establishing the first, third, fifth, and eighth transistors to be turned on during a third period, establishing the first, third, fifth, eighth, and ninth transistors to be turned on during a fourth period, establishing the first, third, fifth, and sixth transistors to be turned on during a fifth period, establishing the second, fifth, and sixth transistors to be turned on during a sixth period, establishing the second, third, fourth, and sixth transistors to be turned on during a seventh period, and establishing the second, third, fourth, and seventh transistors to be turned on during an eighth period.

In the plasma display, the first voltage can be a positive voltage and the second voltage can be a ground voltage. Alternatively, the first and second voltages can both be positive voltages. Alternatively, the first voltage can be a positive voltage and the second voltage can be a negative voltage.

According to another aspect of the present invention, there is provided a method of driving a plasma display that includes a plurality of first electrodes, the method includes providing energy stored in a first capacitor to the plurality of first electrodes through an inductor while applying a first voltage to the plurality of first electrodes, the first capacitor including a first terminal coupled to a first power source for supplying a second voltage, providing energy stored in a second capacitor to the plurality of first electrodes through the inductor, the second capacitor including a first terminal coupled to a second terminal of the first capacitor and a second terminal coupled to a second power source for supplying a third voltage, providing energy stored in the first power source and the second capacitor to the plurality of first electrodes through the inductor, applying a fourth voltage to the plurality of first electrodes through the first power source, the first capacitor, and the second capacitor, recovering energy stored in the plurality of first electrodes to the second capacitor and the first power source through the inductor, recovering the energy stored in the plurality of first electrodes to the second capacitor and the second power source through the inductor, recovering the energy stored in the plurality of first electrodes to the first capacitor and the first power source through the inductor and applying the first voltage to the plurality of first electrodes through the first and second capacitors and the second power source.

The plasma display can further include a transistor including a body diode between a node of the first and second capacitors and the inductor or between the inductor and the plurality of first electrodes, and the energy stored in the plurality of first electrodes is recovered through the body diode of the transistor. The plasma display can further include a transistor including a body diode between a node of the first and second capacitors and the inductor or between the inductor and the plurality of first electrodes, and the energy is provided to the plurality of first electrodes through the body diode of the transistor.

According to yet another aspect of the present invention, there is provided a driver of a plasma display that includes a plurality of first electrodes, the driver including an inductor including a first terminal coupled to the plurality of first electrodes, a first capacitor including a first terminal coupled to a second terminal of the inductor and a second terminal coupled to the plurality of first electrodes, a second capacitor including a first terminal coupled to the second terminal of the inductor and a second terminal coupled to the plurality of first electrodes, a current path adapted to change a voltage at the plurality of first electrodes through the inductor coupled between a node of the first and second capacitors and the plurality of first electrodes and a switching unit adapted to selectively apply a first voltage and a second voltage that is lower than the first voltage to the second terminal of the first capacitor or the second terminal of the second capacitor.

The current path can further include a transistor coupled between the node of the first and second capacitors and the second terminal of the inductor or between the first terminal of the inductor and the plurality of first electrodes. The transistor can be adapted to increase a voltage at the plurality of first electrodes while applying the second voltage to the second terminal of the first capacitor upon being turned on, the transistor can be further adapted to further increase the voltage at the plurality of first electrodes while applying the second voltage to the second terminal of the second capacitor upon being turned on, the transistor can be further adapted to further increase the voltage at the plurality of first electrodes while applying the first voltage to the second terminal of the second capacitor upon being turned on, the driver can be adapted to apply a third voltage to the plurality of first electrodes through the second terminal of the first capacitor while applying the first voltage to the second terminal of the second capacitor, the transistor can be further adapted to decrease the voltage at the plurality of first electrodes while applying the first voltage to the second terminal of the second capacitor upon being turned on, the transistor can be further adapted to further decrease the voltage at the plurality of first electrodes while applying the second voltage to the second terminal of the second capacitor upon being turned on, the transistor can be further adapted to further decrease the voltage at the plurality of first electrodes while applying the second voltage to the second terminal of the first capacitor upon being turned on and the driver can be further adapted to apply a fourth voltage to the plurality of first electrodes through the second terminal of the second capacitor while applying the first voltage through the second terminal of the first capacitor. The third voltage can correspond to a voltage obtained by adding the second voltage and a voltage charged in the first and second capacitors, and the fourth voltage can correspond to a voltage obtained by subtracting the voltage charged in the first and second capacitors from the first voltage.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a diagram representing a plasma display according to an exemplary embodiment of the present invention;

FIG. 2 is a diagram representing driving waveforms according to a first exemplary embodiment of the present invention;

FIG. 3 is a diagram representing a sustain discharge driving circuit of a scan electrode driver for generating the driving waveform shown in FIG. 2;

FIG. 4 is a signal timing diagram of the sustain discharge driving circuit for generating the driving waveform shown in FIG. 2;

FIG. 5A to FIG. 5H respectively show diagrams of operations of the sustain discharge driving circuit shown in FIG. 3 according to the signal timing shown in FIG. 4;

FIG. 6 is a diagram of another sustain discharge driving circuit for generating the driving waveform shown in FIG. 2;

FIG. 7 is a signal timing diagram of the sustain discharge driving circuit for generating the driving waveform shown in FIG. 2; and

FIG. 8A to FIG. 8C are diagrams representing driving waveforms of the plasma display according to second to fourth exemplary embodiment of the present invention.

### DETAILED DESCRIPTION OF THE INVENTION

In the following detailed description, only certain exemplary embodiments of the present invention have been shown and described, simply by way of illustration. As those skilled in the art would realize, the described embodiments can be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element can be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

When it is described in the specification that a voltage is maintained, it should not be understood to strictly imply that the voltage is maintained exactly at a predetermined voltage. To the contrary, even if a voltage difference between two points varies, the voltage difference is expressed to be maintained at a predetermined voltage in the case that the variance is within a range allowed within design constraints or in the case that the variance is caused due to a parasitic component that is usually disregarded by a person of ordinary skill in the art. In addition, since threshold voltages of semiconductor elements (e.g., a transistor and a diode) are very low compared to a discharge voltage, they are considered to be 0V.

A plasma display according to an exemplary embodiment of the present invention, and a driving apparatus and a driving method thereof, will now be described with reference to the figures.

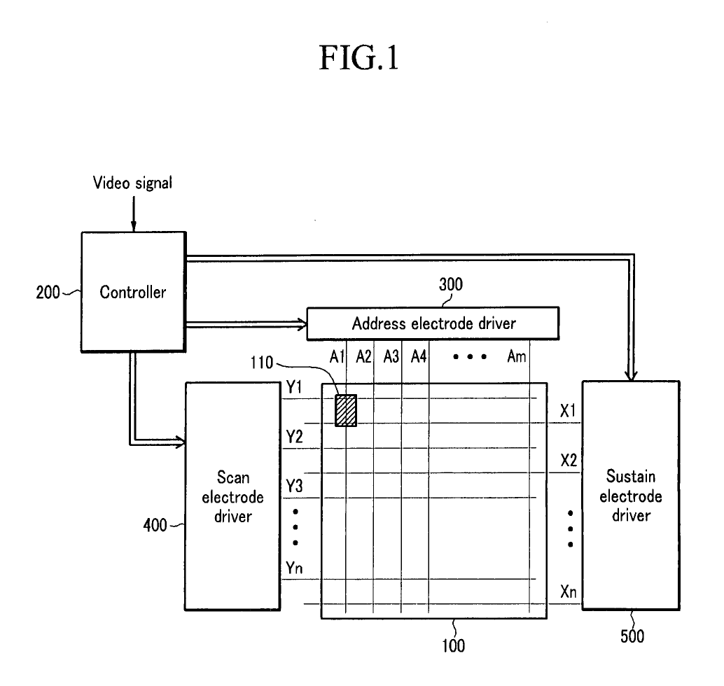

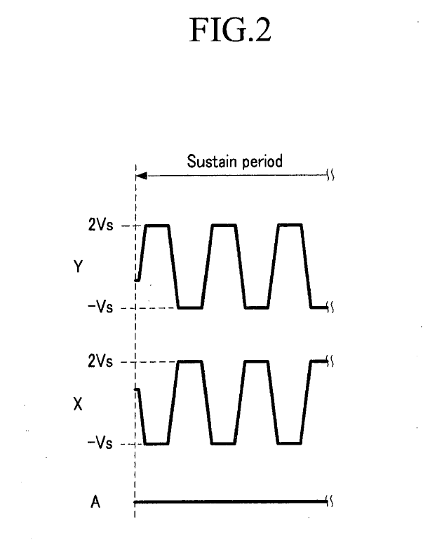

Turning to FIGS. 1 and 2, FIG. 1 shows a diagram representing a plasma display according to an exemplary embodiment of the present invention, and FIG. 2 shows a diagram representing driving waveforms according to a first exemplary embodiment of the present invention. In FIG. 2, for better understanding and ease of description, the driving waveforms will be described based on a cell formed by one A electrode, one Y electrode, and one X electrode, and the A, Y, and X electrodes are respectively denoted by A, Y, and X.

As shown in FIG. 1, a plasma display according to an exemplary embodiment of the present invention includes a plasma display panel (PDP) 100, a controller 200, an address electrode driver 300, a scan electrode driver 400, and a sustain electrode driver 500. The PDP 100 includes a plurality of address electrodes A1 to Am (hereinafter referred to as “A electrodes”) extending in a column direction, and a plurality of sustain and scan electrodes X1 to Xn and Y1 to Yn (hereinafter respectively referred to as “X electrodes” and “Y electrodes” respectively) extending in a row direction by pairs. The X electrodes X1 to Xn are formed in correspondence to the Y electrodes Y1 to Yn, and a display operation is performed by the X and Y electrodes in the sustain period. The Y and X electrodes Y1 to Yn and X1 to Xn are arranged perpendicular to the A electrodes A1 to Am. Here, a discharge space formed at an area where the address electrodes A1 to Am cross the sustain and scan electrodes X1 to Xn and Y1 to Yn to form a discharge cell 110. The configuration of the PDP 100 shown in FIG. 1 is an example, and however other exemplary configurations can be applied in the present invention.

The controller 200 outputs X, Y, and A electrode driving control signals after externally receiving an image signal. In addition, the controller 200 operates on each frame divided into a plurality of subfields having respective weight values, and each subfield includes an address period and a sustain period. The address, scan, and sustain electrode drivers 300, 400, and 500 respectively apply driving voltages to the A electrodes A1-Am, the Y electrodes Y1-Yn, and the X electrodes X1-Xn according to the driving control signals from the controller 200.

In further detail, as shown in FIG. 2, during the sustain period of each subfield, while the address electrode driver 300 applies a reference voltage (0V in FIG. 2) to the A electrode A, the scan electrode driver 400 applies a sustain pulse alternately having a high level voltage 2Vs and a low level voltage −Vs to the Y electrode Y a number of times corresponding to a weight value of the corresponding subfield. In addition, the sustain electrode driver 500 applies the sustain pulse to the X and Y electrodes X and Y, and the sustain pulses applied to the X and Y electrode X and Y have opposite phases. Accordingly, a voltage difference between the respective Y electrodes and X electrodes alternately has a 3Vs voltage and a −3Vs voltage, and a sustain discharge is generated in a turn-on cell (i.e., a cell to be turned on) a predetermined number of times.

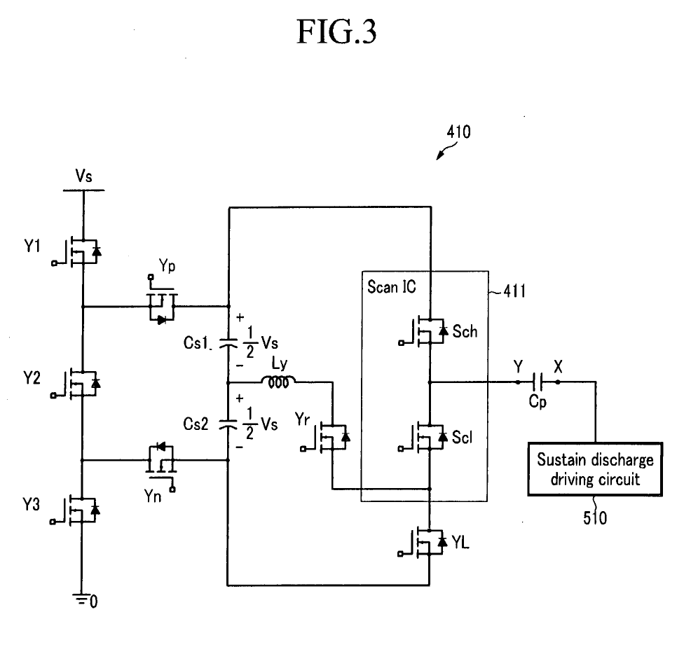

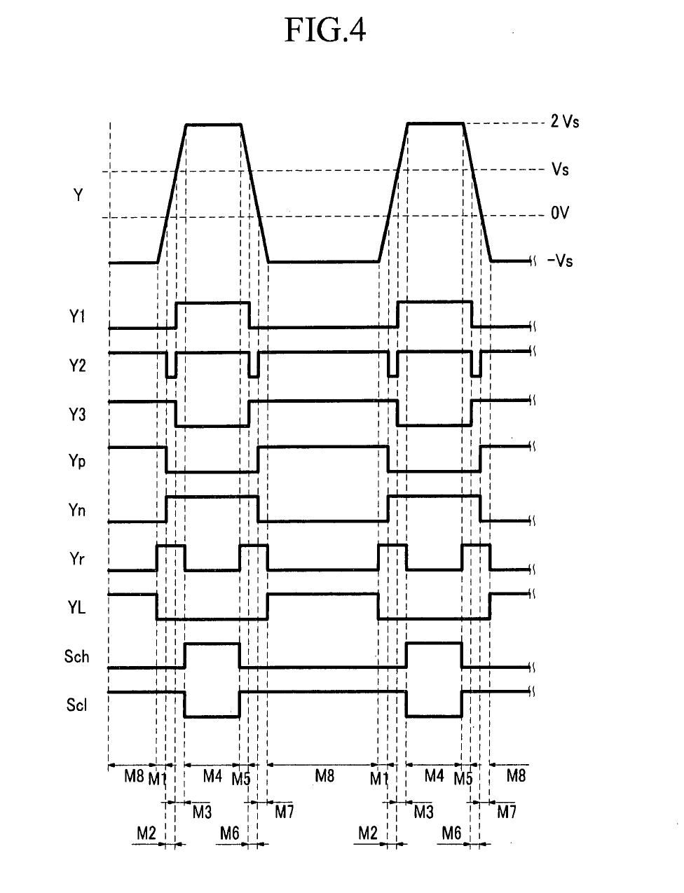

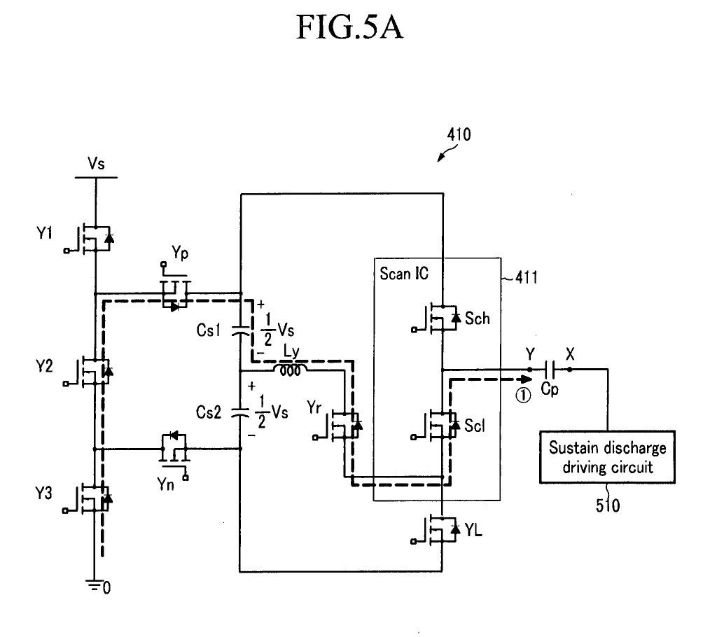

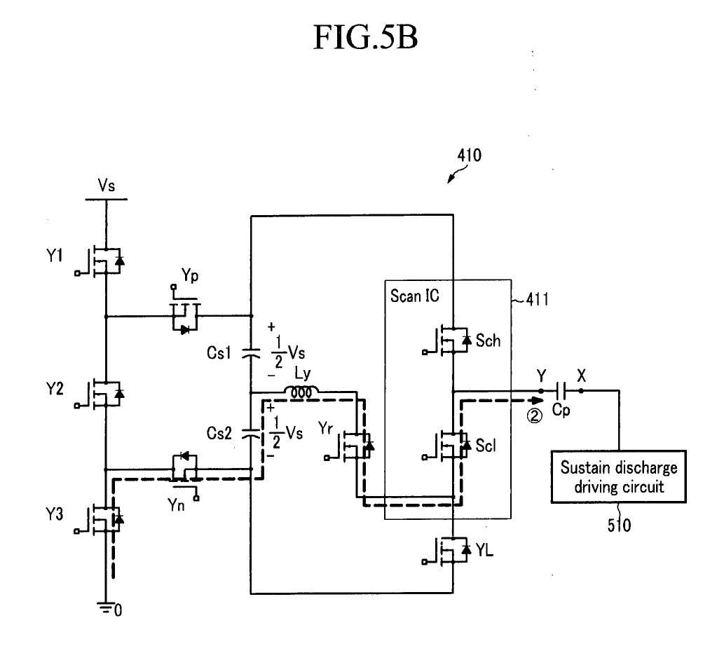

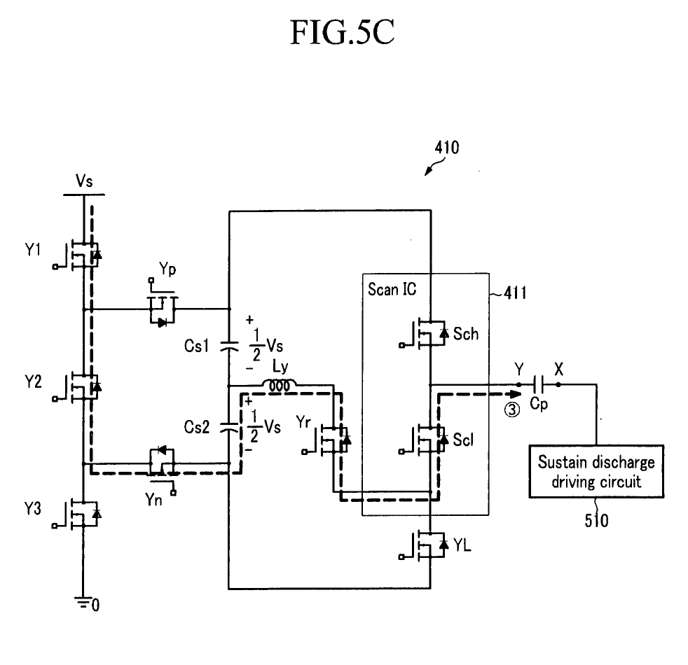

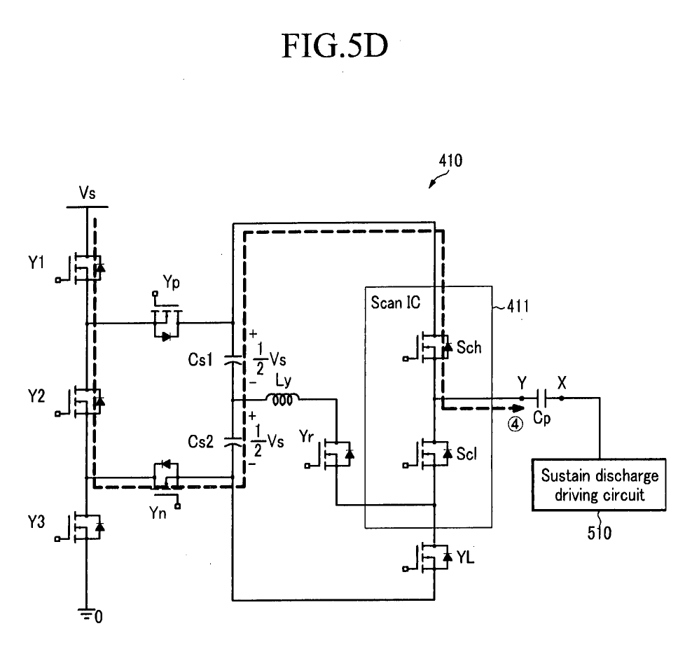

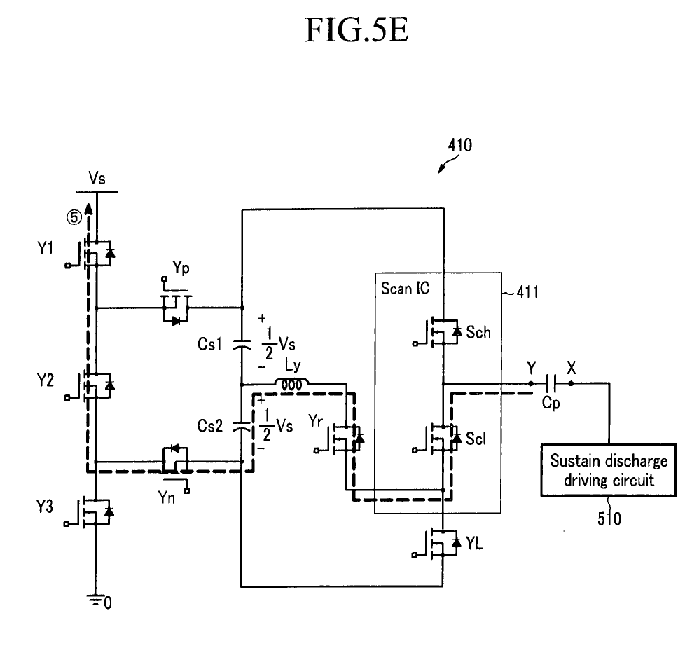

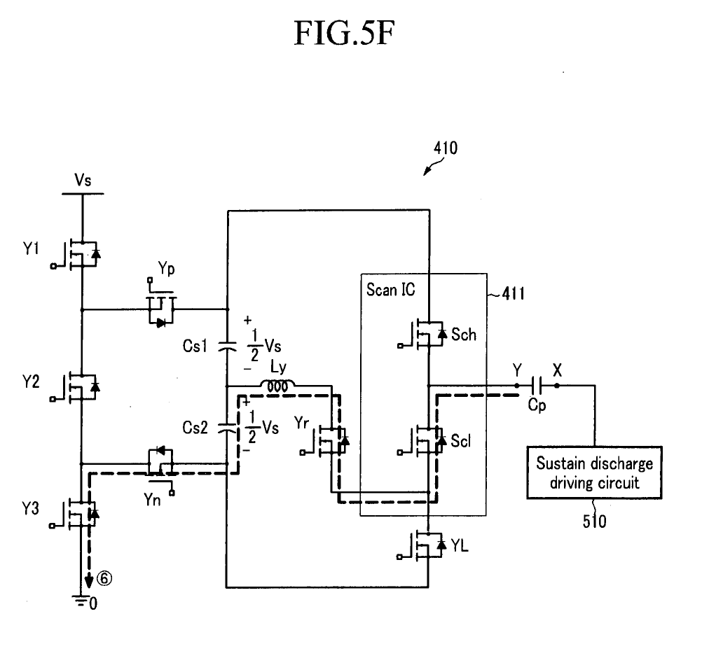

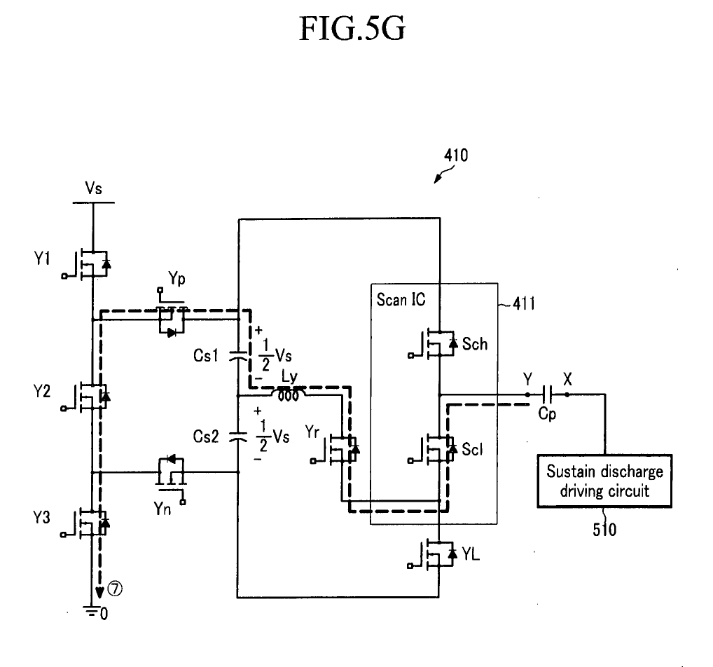

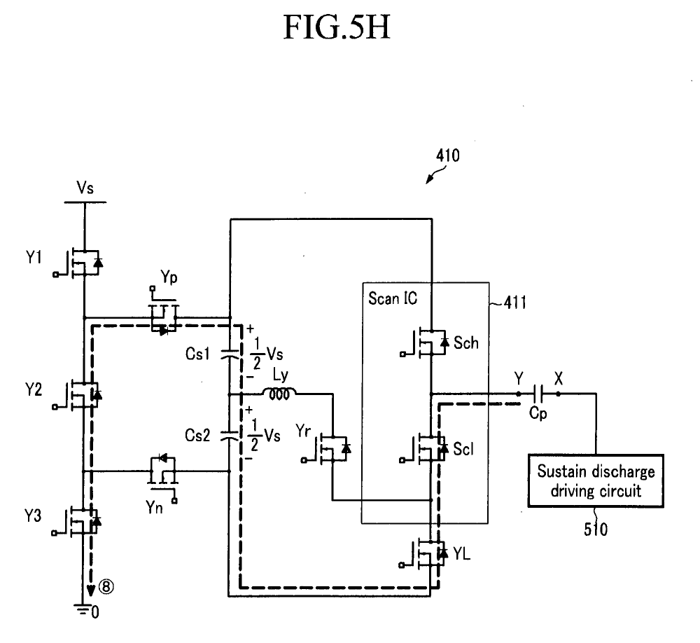

A sustain discharge driving circuit for supplying the sustain pulse shown in FIG. 2 will now be described with reference to FIG. 3, FIG. 4, and FIG. 5A to FIG. 5H. FIG. 3 shows a diagram representing a sustain discharge driving circuit 410 of the scan electrode driver 400 for generating the driving waveform shown in FIG. 2. In FIG. 3, for better understanding and ease of description, only the sustain discharge driving circuit 410 connected to the plurality of Y electrodes Y1-Yn is illustrated, and the sustain discharge driving circuit 410 can be formed in the scan electrode driver 400 shown in FIG. 1. In addition, a sustain discharge driving circuit 510 is coupled to the plurality of X electrodes X1 to Xn. The sustain discharge driving circuit 510 can be formed in the sustain electrode driver 500, and a configuration of the sustain discharge driving circuit 510 can be similar to that of the sustain discharge driving circuit 410. Further, in the sustain discharge driving circuit 410, for better understanding and ease of description, one X electrode X and one Y electrode Y are illustrated, and a capacitance formed by the X electrode X and the Y electrode Y is illustrated as a panel capacitor Cp.

As shown in FIG. 3, the sustain discharge driving circuit 410 includes transistors Y1, Y2, Y3, Yp, Yn, Yr, and YL, capacitors Cs1 and Cs2, an inductor Ly, and a scan integrated circuit (hereinafter referred to as a “scan IC”) 411. In FIG. 3, the transistors Y1, Y2, Y3, Yp, Yn, Yr, YL, Sch, and Scl are illustrated as n-channel field effect transistors (particularly n-channel metal oxide semiconductor (NMOS) transistors), and a body diode can be formed from a source to a drain in the transistors Y1, Y2, Y3, Yp, Yn, Yr, YL, Sch, and Scl. Rather than using the NMOS transistor, other transistors that can perform a similar function can be used for the transistors Y1, Y2, Y3, Yp, Yn, Yr, YL, Sch, and Scl. In addition, the transistors Y1, Y2, Y3, Yp, Yn, Yr, YL, Sch, and Scl are respectively illustrated as individual transistors in FIG. 3, and the respective transistors Y1, Y2, Y3, Yp, Yn, Yr, YL, Sch, and Scl can include a plurality of transistors coupled in parallel to each other.

As shown in FIG. 3, the scan IC 411 includes a first input terminal and a second input terminal, and an output terminal thereof is coupled to the Y electrode Y of the panel capacitor Cp. The scan IC 411 selectively applies a voltage at the first input terminal and a voltage at the second input terminal to the Y electrode Y to select a turn-on cell during the address period. In FIG. 3, while it is illustrated that one Y electrode Y is coupled to the scan IC 411, the scan IC 411 can include a plurality of output terminals. That is, the plurality of Y electrodes Y1 to Yn can be coupled to the plurality of output terminals of the scan IC 411. In this case, when the number of output terminals of the scan IC 411 is less than the number of the Y electrodes Y1 to Yn, a plurality of scan ICs 411 can be used.

The scan IC 411 includes transistors Sch and Scl. A source of the transistor Sch and a drain of the transistor Scl are respectively coupled to the Y electrode of the panel capacitor Cp, a drain of the transistor Sch is coupled to the first input terminal of the scan IC 411, and a source of the transistor Scl is coupled to the second input terminal of the scan IC 411. The inductor Ly includes a first terminal coupled to the second input terminal of the scan IC 411 and a second terminal coupled to a second terminal of the capacitor Cs1 and a first terminal of the capacitor Cs2. The transistor Y1 includes a source coupled to a first terminal of the capacitor Cs1 and a drain coupled to a power source Vs for supplying a Vs voltage, and the transistor Y3 includes a drain coupled to a second terminal of the capacitor Cs2 and a source coupled to a ground terminal 0. In addition, the first terminal of the capacitor Cs1 is coupled to the first input terminal of the scan IC 411. The transistor Y2 includes a drain coupled to the source of the transistor Y1 and a source coupled to the drain of the transistor Y3. The transistor Yp is coupled between the drain of the transistor Y1 and the first terminal of the capacitor Cs1, and the transistor Yn is coupled between the second terminal of the capacitor Cs2 and the transistor Y3. In this case, the transistors Y1, Y2, Y3, Yp, and Yn operate as switching means for selectively applying the Vs voltage or a 0V voltage to the first terminal of the capacitor Cs1 or the second terminal of the capacitor Cs2. In addition, the transistors Y1 and Y3 form a path for charging the two capacitors Cs1 and Cs2 (i.e., a path of the power source Vs, the transistor Y1, the body diode of the transistor Yp, the body diode of the transistor Yn, the transistor Y3, and the ground terminal) when the transistors Y1 and Y3 are turned on and the capacitors Cs1 and Cs2 are respectively charged with the Vs/2 voltage through the path. Further, the transistor Yr is coupled between the first terminal of the inductor Ly and the second input terminal of the scan IC 411, and the transistor YL is coupled between the second terminal of the capacitor Cs2 and the second input terminal of the scan IC 411. Here, the transistor Yr can be coupled between the capacitors Cs1 and Cs2 and the inductor Ly.

An operation of the sustain discharge driving circuit 410 shown in FIG. 3 will be described with reference to FIG. 4 and FIG. 5A to FIG. 5H. FIG. 4 shows a signal timing diagram of the sustain discharge driving circuit 410 for generating the driving waveform shown in FIG. 2, and FIG. 5A to FIG. 5H respectively show diagrams of operations of the sustain discharge driving circuit 410 shown in FIG. 3 according to the signal timing shown in FIG. 4. It is assumed that the transistors Y2, Y3, Yp, YL, and Scl are turned on and the −Vs voltage is applied to the Y electrode before starting a mode 1 M1.

As shown in FIG. 4 and FIG. 5A, at the mode 1 (M1), the transistor Yr is turned on, the transistors YL and Scl are turned off, and a resonance is generated through a path (X of the ground terminal 0, the body diode of the transistors Y3, Y2, and Yp, the capacitor Cs1, the inductor Ly, the transistor Yr, the body diode of the transistor Scl, and the Y electrode Y of the panel capacitor Cp. As a result, energy charged in the capacitor Cs1 is provided to the Y electrode Y through the inductor Ly, and therefore a voltage at the Y electrode Y is increased from the −Vs voltage to the 0V voltage.

Subsequently, at a mode 2 (M2), the transistor Yn is turned on, the transistors Y2 and Yp are turned off, and as shown in FIG. 5B, the resonance is generated through a path \hat{2} of the ground terminal 0, the body diode of the transistor Y3, the transistor Yn, the capacitor Cs2, the inductor Ly, the transistor Yr, the body diode of the transistor Scl, and the Y electrode Y of the panel capacitor Cp. As a result, energy charged in the capacitor Cs2 is provided to the Y electrode Y through the inductor Ly, and therefore the voltage at the Y electrode Y is increased from the 0V voltage to the Vs voltage. In this case, since the drain of the transistor Y1 is coupled to the power source Vs and a source voltage of the transistor Y2 is the 0V voltage, a voltage difference between the two transistors Y1 and Y2 becomes the Vs voltage. Accordingly, the transistor having the Vs/2 voltage can be used as the transistors Y1 and Y2.

At a mode 3 (M3), the transistors Y1 and Y2 are turned on, the transistor Y3 are turned off, and as shown in FIG. 5C, the resonance is generated through a path (X of the power source Vs, the transistors Y1, Y2, and Yn, the capacitor Cs2, the inductor Ly, the transistor Yr, the body diode of the transistor Scl, and the Y electrode of the panel capacitor Cp. As result, the energy charged in the capacitor Cs2 is provided to the Y electrode Y through the inductor Ly, and therefore the voltage at the Y electrode Y is increased from the Vs voltage to a 2Vs voltage.

Subsequently, at a mode 4 (M4), the transistor Sch is turned on, the transistor Yr is turned off, and as shown in FIG. 5D, the 2Vs voltage is applied to the Y electrode through a path \hat{4} of the power source Vs, the transistors Y1, Y2, and Yn, the capacitors Cs2 and Cs1, the transistor Sch, and the Y electrode of the panel capacitor Cp. In this case, since a drain voltage of the transistor Y3 is the Vs voltage, the voltage difference between the drain and source of the transistor Y1 becomes the Vs voltage. Further, since the source voltage of the transistor Yp is the Vs voltage and the drain voltage of the transistor Yp is the 2Vs voltage, the voltage difference between the drain and the source of the transistor Yp also becomes the Vs voltage. Accordingly, a transistor having the Vs voltage can be used as the transistors Y3 and Yp. In addition, since the source voltage of the transistor YL is the 2Vs voltage and the drain voltage of the transistor Scl is the 2Vs voltage, the voltage difference between the two transistors Scl and YL becomes the Vs voltage. Accordingly, a transistor having the Vs/2 voltage can be used as the transistors Scl and YL.

At a mode 5 (M5), the transistor Scl is turned on, the transistor Sch is turned off, and as shown in FIG. 5E, the resonance is generated through a path \hat{5} of the Y electrode of the panel capacitor Cp, the transistor Scl, the body diode of the transistor Yr, the inductor Ly, the capacitor Cs2, the body diode of the transistors Yn, Y2, and Y1, and the power source Vs. As a result, energy stored in the panel capacitor Cp is recovered to the power source Vs through the inductor Ly, the voltage at the Y electrode Y is reduced from the 2Vs voltage to the Vs voltage.

At a mode 6 (M6), the transistor Y3 is turned on, the transistors Y1 and Y2 are turned off, and as shown in FIG. 5F, the resonance is generated through a path \hat{6} of the Y electrode of the panel capacitor Cp, the transistor Scl, the body diode of the transistor Yr, the inductor Ly, the capacitor Cs2, the body diode of the transistor Yn, the transistor Y3, and the ground terminal 0. As a result, the energy stored in the panel capacitor Cp is recovered to the ground terminal 0 through the inductor Ly, and therefore the voltage at the Y electrode Y is reduced from the Vs voltage to the 0V voltage.

At a mode 7 (M7), the transistors Yp and Y2 are turned on, the transistor Yn is turned off, and as shown in FIG. 5G, the resonance is generated through a path (Z of the Y electrode Y of the panel capacitor Cp, the transistor Scl, the body diode of the transistor Yr, the inductor Ly, the capacitor Cs1, the transistors Yp, Y2, and Y3, and the ground terminal 0. As a result, the energy stored in the panel capacitor Cp is recovered to the ground terminal 0 through the inductor Ly, and therefore the voltage at the Y electrode Y is reduced from the 0V voltage to the −Vs voltage.

Finally, at a mode 8 (M8), the transistor YL is turned on, and as shown in FIG. 5H, the 0V voltage is applied to the Y electrode through a path 6 of the Y electrode of the panel capacitor Cp, the transistors Scl and YL, the capacitors Cs2 and Cs1, the transistors Yp, Y2, and Y3, and the ground terminal 0. In this case, since the source voltage of the transistor Y1 is the 0V voltage, the voltage difference between the drain and the source of the transistor Y1 becomes the Vs voltage. In addition, since the source voltage of the transistor Yn is the −Vs voltage and the drain voltage of the transistor Yn is the 0V voltage, the voltage difference between the drain and the source of the transistor Yn becomes the Vs voltage. Further, since the source voltage of the transistor Yr is the 0V voltage and the drain voltage of the transistor Yr is the −Vs/2 voltage, the voltage difference between the drain and the source of the transistor Yr becomes the Vs/2 voltage. Accordingly, a transistor having the Vs voltage can be used as the transistors Y1 and Yn, and a transistor having the Vs/2 voltage can be used as the transistor Yr. In addition, since the drain voltage of the transistor Sch is the 0V voltage and the source voltage of the transistor Sch is the −Vs voltage, the voltage difference between the drain and the source of the transistor Sch becomes the Vs voltage. Accordingly, a transistor having the Vs voltage can be used as the transistor Sch.

As described, since the transistor having the Vs/2 voltage (i.e., ⅙ of a voltage corresponding to a difference between the high level voltage 2Vs and the low level voltage −Vs of the sustain pulse) can be used as the transistors Scl, Yr, Y2, and YL, and the transistor having the Vs voltage (i.e., ⅓ of the voltage corresponding to the difference between the high level voltage 2Vs and the low level voltage −Vs) can be used as the transistors Y1, Y3, Yp, Yn, and Sch, the circuit cost can be reduced. Further, since the mode 1 to mode 8 (M1 to M8) are performed the number of times corresponding to a weight value of the corresponding subfield during the sustain period, the 2Vs voltage and the −Vs voltage are alternately applied to the Y electrodes.

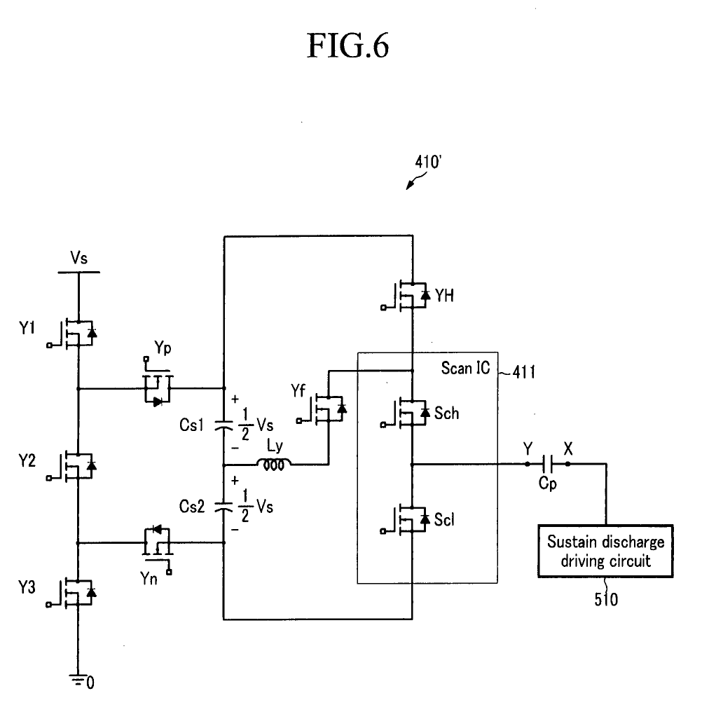

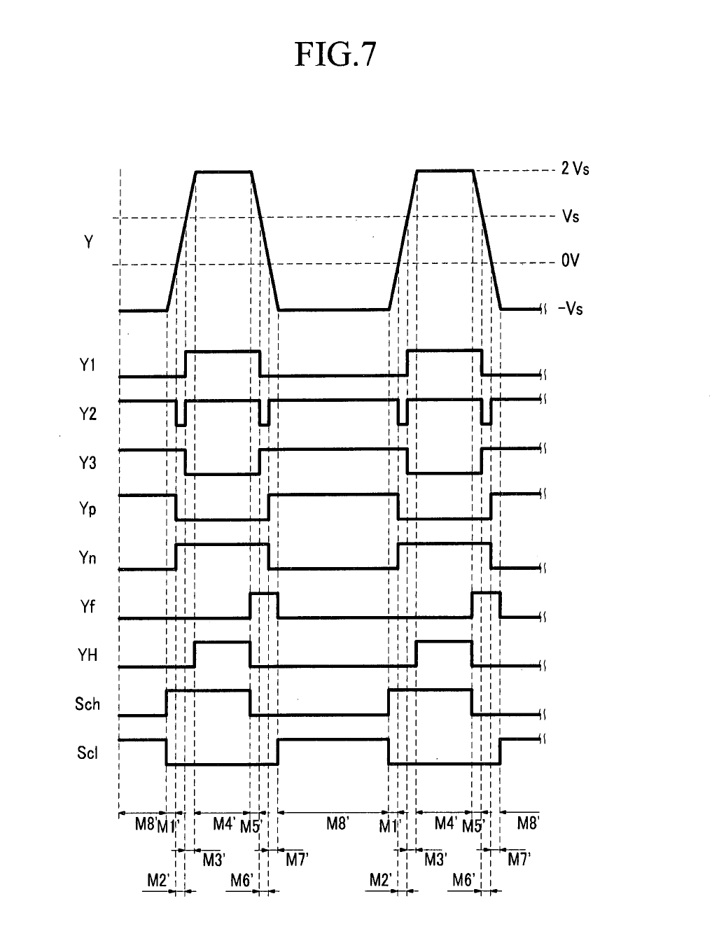

A sustain discharge driving circuit 410′ shown in FIG. 6 can generate the sustain pulse shown in FIG. 2. FIG. 6 is a diagram of another sustain discharge driving circuit 410′ for generating the driving waveform shown in FIG. 2, and FIG. 7 is a signal timing diagram of the sustain discharge driving circuit 410′ for generating the driving waveform shown in FIG. 2. As shown in FIG. 6, the sustain discharge driving circuit 410′ is the same as the sustain discharge driving circuit 410 except that a transistor Yf instead of the transistor Yr is coupled between the second terminal of the inductor Ly and the first input terminal of the scan IC 411, and a transistor YH instead of the transistor YL is coupled to the drain of the transistor Yp and the first input terminal of the scan IC 411. When it is assumed that the transistors Y2, Y3, Yp, and Scl are turned on and the sustain discharge driving circuit 410′ before a mode 1 M1′ is started as shown in FIG. 7, the transistor Scl is turned off and the transistor Sch is turned on at the mode 1 (M1)′, the transistors Y2 and Yp are turned off and the transistor Yn is turned on at a mode 2 (M2′), the transistor Y3 is turned off and the transistors Y1 and Y2 turned on at a mode 3 (M3′), the transistor YH is turned on at a mode 4 (M4′), the transistors YH and Sch are turned off and the transistor Yf is turned on at a mode 5 (M5′), the transistors Y1 and Y2 are turned off and the transistor Y3 is turned on at a mode 6 (M6′), the transistor Yn is turned off and the transistors Y2 and Yp are turned on at a mode 7 (M7′), and the transistor Yf is turned off and the transistor Scl is turned on at a mode 8 (M8′). In addition, since the mode 1 to mode 8 (M1′ to M8′) are performed the number of times corresponding to a weight value of the corresponding subfield during the sustain period, the 2Vs voltage and the −Vs voltage can be alternately applied to the Y electrode.

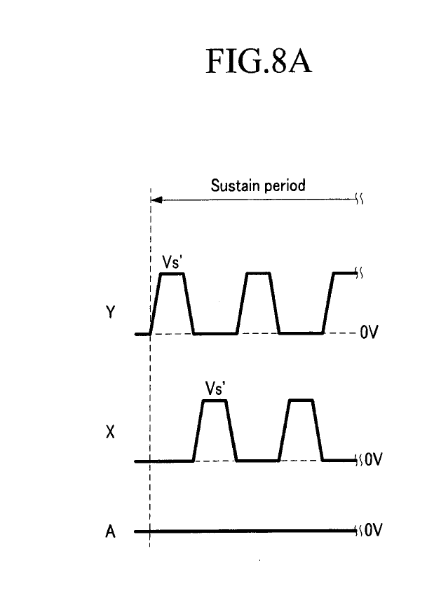

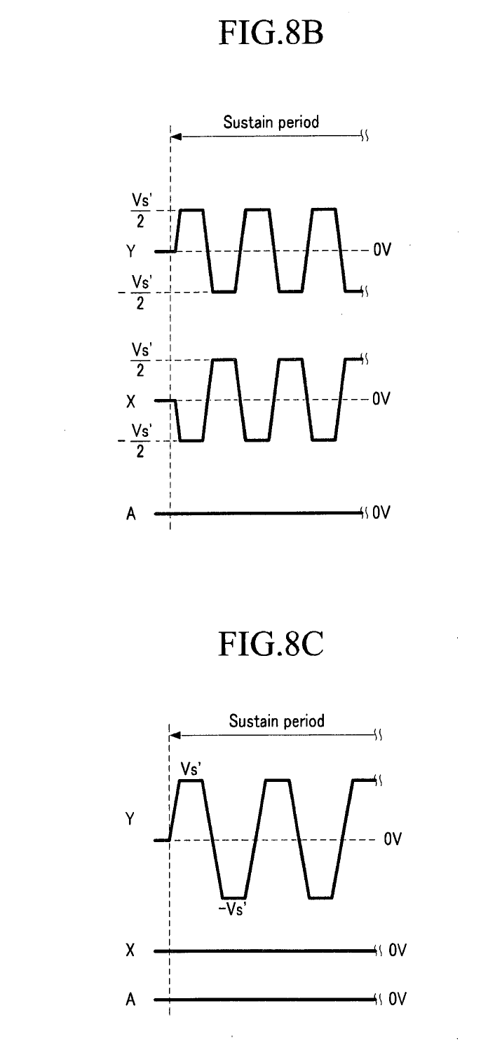

It has been described that the driving waveform according to the first exemplary embodiment of the present invention is generated by using the sustain discharge driving circuits 410 and 410′ shown in FIG. 3 and FIG. 6. In the driving waveform shown in FIG. 2, a voltage difference between the Y electrode and the X electrode alternately is the 3Vs voltage and the −3Vs voltage. In this case, if the size of the 3Vs voltage is the same as that of a Vs′ voltage, the driving waveform shown in FIG. 8A to FIG. 8C can be applied.

FIG. 8A to FIG. 8C are diagrams representing driving waveforms of the plasma display according to second to fourth exemplary embodiment of the present invention. As shown in FIG. 8A, during the sustain period, the sustain pulse alternately having the high level voltage Vs′ and the low level voltage 0V can be applied to the plurality of Y electrodes Y1 to Yn and the plurality of X electrodes X1 to Xn with opposite phases. In this case, in the sustain discharge driving circuits 410 and 410′, the drain of the transistor Y1 is coupled to a power source for supplying a 2Vs′/3 voltage and the source of the transistor Y1 is coupled to a power source Vs′/3 for supplying a Vs′/3 voltage.

In addition, as shown in FIG. 8B, the sustain pulse alternately having a high level voltage Vs′/2 and a low level voltage Vs′/2 can be applied to the plurality of Y electrodes Y1 to Yn and the plurality of X electrodes X1 to Xn with opposite phases. That is, the scan electrode driver 400 applies the sustain pulse alternately having the high level voltage (Vs′ or Vs′/2) and the low level voltage (0V or −Vs′/2) to the plurality of Y electrodes Y1 to Yn the number of times corresponding to the weight value of the corresponding subfield, and the sustain electrode driver 500 applies the sustain pulse to the plurality of X electrodes X1 to Xn with an opposite phase to the sustain pulse applied to the Y electrodes Y1 to Yn. Accordingly, the voltage difference between the Y electrode and the X electrode is alternately the Vs′ voltage and the −Vs′ voltage, and therefore the sustain discharge is generated a predetermined number of times in the turn-on discharge cell. In this case, in the sustain discharge driving circuit 410 and 410′, the drain of the transistor Y1 is coupled to a power source Vs′/6 for supplying a Vs′/6 voltage and the source of the transistor Y3 is coupled to a power source −Vs′/6 for supplying a −Vs′/6 voltage.

In addition, as shown in FIG. 8C, the sustain pulse can be applied to one of the X electrode and the Y electrode. That is, during the sustain period, while the 0V voltage is applied to the X electrode, the sustain pulse alternately having the Vs′ voltage and the −Vs′ voltage is applied to the Y electrode. Accordingly, the voltage difference between the Y electrode and the X electrode is alternately the Vs′ voltage and the −Vs′ voltage, and therefore the sustain discharge can be generated the predetermined number of times in the turn-on discharge cell. In this case, in the sustain discharge driving circuits 410 and 410′, the drain of the transistor Y1 is coupled to the power source Vs′/3 for supplying the Vs′/3 voltage and the source of the transistor Y3 is coupled to a power source −Vs′/3 for supplying the −Vs′/3 voltage. In this case, the 0V voltage can be applied to the X electrode. As described above, according to the exemplary embodiment of the present invention, since a transistor having a low voltage can be used in the sustain discharge driving circuit, a circuit cost can be reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A plasma display, comprising:
a plurality of first electrodes;
a first transistor including a first terminal coupled to a first power source adapted to supply a first voltage;
a second transistor including a first terminal coupled to a second power source adapted to supply a second voltage that is lower than the first voltage;
a third transistor including a first terminal coupled to a second terminal of the first transistor and a second terminal coupled to a second terminal of the second transistor;
a first capacitor that is charged with a third voltage and that includes a first terminal coupled to the second terminal of the first transistor and the plurality of first electrodes;
a second capacitor that is charged with a fourth voltage, and that includes a first terminal coupled to a second terminal of the first capacitor and a second terminal coupled to the second terminal of the second transistor and the plurality of first electrodes;
a fourth transistor coupled between the first terminal of the first capacitor and the second terminal of the first transistor;
a fifth transistor coupled between the second terminal of the second capacitor and the second terminal of the second transistor; and
a current path coupled between a node of the first and second capacitors and the plurality of first electrodes to change a voltage at the plurality of first electrodes.

2. The plasma display of claim 1, wherein the current path comprises:
an inductor including a first terminal coupled to the node of the first and second capacitors; and
a sixth transistor including a first terminal coupled to a second terminal of the inductor and a second terminal coupled to the plurality of first electrodes.

3. The plasma display of claim 2, wherein a body diode is connected between the first terminal and the second terminal in the sixth transistor.

4. The plasma display of claim 3, further comprising a plurality of seventh transistors respectively including a first terminal coupled to the plurality of first electrodes and a second terminal coupled to the first terminal of the first capacitor, wherein the current path comprises a plurality of eighth transistors respectively including a first terminal coupled to the second terminal of the sixth transistor and a second terminal coupled to the plurality of first electrodes.

5. The plasma display of claim 4, further comprising a ninth transistor coupled between the first terminal of the plurality of eighth transistors and the second terminal of the second capacitor.

6. The plasma display of claim 5, further comprising a controller adapted to establish the second, third, fourth, and sixth transistors to be turned on during a first period, establishing the second, fifth, and sixth transistors to be turned on during a second period, establishing the first, third, fifth, and sixth transistors to be turned on during a third period, establishing the first, third, fifth, seventh, and ninth transistors to be turned on during a fourth period, establishing the first, third, fifth, and eighth transistors to be turned on during a fifth period, establishing the second, fifth, and eighth transistors to be turned on during a sixth period, establishing the second, third, fourth, and sixth transistors to be turned on during a seventh period, and establishing the second, third, fourth, and eighth transistors to be turned on during an eighth period.

7. The plasma display of claim 3, further comprising a plurality of seventh transistors including a first terminal coupled the plurality of first electrodes and a second terminal coupled to the second terminal of the second capacitor, wherein the current path comprises a plurality of eighth transistors including a first terminal coupled to the second terminal of the sixth transistor and a second terminal coupled to the plurality of first electrodes.

8. The plasma display of claim 7, further comprising a ninth transistor coupled between the first terminal of the plurality of eighth transistors and the first terminal of the first capacitor.

9. The plasma display of claim 8, further comprising a controller adapted to establish the second, third, fourth, and eighth transistors to be turned on during a first period, establishing the second, fifth, and eighth transistors to be turned on during a second period, establishing the first, third, fifth, and eighth transistors to be turned on during a third period, establishing the first, third, fifth, eighth, and ninth transistors to be turned on during a fourth period, establishing the first, third, fifth, and sixth transistors to be turned on during a fifth period, establishing the second, fifth, and sixth transistors to be turned on during a sixth period, establishing the second, third, fourth, and sixth transistors to be turned on during a seventh period, and establishing the second, third, fourth, and seventh transistors to be turned on during an eighth period.

10. The plasma display of claim 1, wherein the first voltage is a positive voltage and the second voltage is a ground voltage.

11. The plasma display of claim 1, wherein the first and second voltages are positive voltages.

12. The plasma display of claim 1, wherein the first voltage is a positive voltage and the second voltage is a negative voltage.

13. A method of driving a plasma display comprising a plurality of first electrodes, the method comprising:
providing energy stored in a first capacitor to the plurality of first electrodes through an inductor while applying a first voltage to the plurality of first electrodes, the first capacitor including a first terminal coupled to a first power source for supplying a second voltage;
providing energy stored in a second capacitor to the plurality of first electrodes through the inductor, the second capacitor including a first terminal coupled to a second terminal of the first capacitor and a second terminal coupled to a second power source for supplying a third voltage;
providing energy stored in the first power source and the second capacitor to the plurality of first electrodes through the inductor;
applying a fourth voltage to the plurality of first electrodes through the first power source, the first capacitor, and the second capacitor;
recovering energy stored in the plurality of first electrodes to the second capacitor and the first power source through the inductor;
recovering the energy stored in the plurality of first electrodes to the second capacitor and the second power source through the inductor;
recovering the energy stored in the plurality of first electrodes to the first capacitor and the first power source through the inductor; and
applying the first voltage to the plurality of first electrodes through the first and second capacitors and the second power source.

14. The method of claim 13, wherein the plasma display further comprises a transistor including a body diode between a node of the first and second capacitors and the inductor or between the inductor and the plurality of first electrodes, and the energy stored in the plurality of first electrodes is recovered through the body diode of the transistor.

15. The method of claim 13, wherein the plasma display further comprises a transistor including a body diode between a node of the first and second capacitors and the inductor or between the inductor and the plurality of first electrodes, and the energy is provided to the plurality of first electrodes through the body diode of the transistor.

16. A driver of a plasma display comprising a plurality of first electrodes, the driver comprising:
an inductor including a first terminal coupled to the plurality of first electrodes;
a first capacitor including a first terminal coupled to a second terminal of the inductor and a second terminal coupled to the plurality of first electrodes;
a second capacitor including a first terminal coupled to the second terminal of the inductor and a second terminal coupled to the plurality of first electrodes;
a current path adapted to change a voltage at the plurality of first electrodes through the inductor coupled between a node of the first and second capacitors and the plurality of first electrodes; and
a switching unit adapted to selectively apply a first voltage and a second voltage that is lower than the first voltage to the second terminal of the first capacitor or the second terminal of the second capacitor.

17. The driver of claim 16, wherein the current path further comprises a transistor coupled between the node of the first and second capacitors and the second terminal of the inductor or between the first terminal of the inductor and the plurality of first electrodes.

18. The driver of claim 17, wherein:
the transistor being adapted to increase a voltage at the plurality of first electrodes while applying the second voltage to the second terminal of the first capacitor upon being turned on;
the transistor is further adapted to further increase the voltage at the plurality of first electrodes while applying the second voltage to the second terminal of the second capacitor upon being turned on;
the transistor is further adapted to further increase the voltage at the plurality of first electrodes while applying the first voltage to the second terminal of the second capacitor upon being turned on;
the driver being adapted to apply a third voltage to the plurality of first electrodes through the second terminal of the first capacitor while applying the first voltage to the second terminal of the second capacitor;
the transistor is further adapted to decrease the voltage at the plurality of first electrodes while applying the first voltage to the second terminal of the second capacitor upon being turned on;
the transistor is further adapted to further decrease the voltage at the plurality of first electrodes while applying the second voltage to the second terminal of the second capacitor upon being turned on;
the transistor is further adapted to further decrease the voltage at the plurality of first electrodes while applying the second voltage to the second terminal of the first capacitor upon being turned on; and
the driver being further adapted to apply a fourth voltage to the plurality of first electrodes through the second terminal of the second capacitor while applying the first voltage through the second terminal of the first capacitor.

19. The driver of claim 18, wherein the third voltage corresponds to a voltage obtained by adding the second voltage and a voltage charged in the first and second capacitors, and the fourth voltage corresponds to a voltage obtained by subtracting the voltage charged in the first and second capacitors from the first voltage.
